(19) United States
(12) Patent Application Publication
(10) Pub. No.: US 2008/0297658 A1
(43) Pub. Date: Dec. 4, 2008

(54) Display

(75) Inventor: Tadahiro Naito, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 12/125,646

(22) Filed: May 22, 2008

(30) Foreign Application Priority Data
May 28, 2007 (JP) 2007-140052

(51) Int. Cl. H04N 5/445

(52) U.S. Cl. 348/564; 348/E05.099

(57) ABSTRACT

This display includes a display portion, a receiving sensitivity detection portion and a control portion so formed as to control the display portion to display an image received from a channel and displayable on the display portion while displaying a set screen enabling the user to select whether or not to display the image currently displayed on the display portion on the basis of receiving sensitivity.

### BACKGROUND OF THE INVENTION

1. Field of the Invention

The present invention relates to a display, and more particularly, it relates to a display setting a display portion not to display images on the basis of receiving sensitivity of a television signal.

2. Description of the Background Art

A display setting a display portion not to display images on the basis of receiving sensitivity of a television signal is known in general, as disclosed in each of Japanese Patent Laying-Open Nos. 2007-5919, 2001-168684 and 2006-270411, for example. A display setting a display portion not to display images on the basis of a synchronous signal included in a television signal is also known, as disclosed in Japanese Patent Laying-Open No. 2001-16524, for example.

A television (display) described in the aforementioned Japanese Patent Laying-Open No. 2007-5919 is so formed as to display a list of numbers of channels transmitting television signals having receiving strength (receiving sensitivity) levels smaller than reference receiving strength on a CRT (display portion) on the basis of the receiving strength levels of the television signals so that the user can select channels to be deleted (so that images received therefrom are not displayed).

A car navigation system (display) provided with a television described in the aforementioned Japanese Patent Laying-Open No. 2001-168684 is so formed as to automatically delete (not to display images received from) channels transmitting television signals having receiving levels (receiving sensitivity levels) lower than a reference signal level (prescribed receiving sensitivity) previously set in a microcomputer (control portion) by comparing the receiving levels of the television signals with the reference signal level.

A television receiver (display) described in the aforementioned Japanese Patent Laying-Open No. 2006-270411 comprises two tuners for receiving television signals, and is so formed as to compare signal levels (receiving sensitivity) of two channels corresponding to the same images (television program) received by the respective tuners with each other thereby automatically deleting (not displaying images received from) the channel having a lower signal level.

A display described in the aforementioned Japanese Patent Laying-Open No. 2001-16524 is so formed as to detect synchronous signals included in television signals, automatically delete a channel transmitting a television signal including no synchronous signal, thereafter detect the synchronous signals included in the television signals transmitted from the undeleted channels and automatically delete a channel transmitting a television signal including no synchronous signal. Thus, the display can reduce the number of errors in detection of the synchronous signals and reliably automatically delete (not display images received from) the channels transmitting television signals including no synchronous signals. The aforementioned Japanese Patent Laying-Open No. 2001-16524 discloses no operation of deleting a channel on the basis of receiving sensitivity.

In the television according to the aforementioned Japanese Patent Laying-Open No. 2007-5919, however, the CRT displays the list of the numbers of the channels transmitting the television signals having the receiving strength levels smaller than the reference receiving strength, and hence the user can easily delete a plurality of channels, but cannot confirm the contents of the deleted channels since the plurality of channels are deleted at once. In this television, therefore, the user cannot delete unnecessary channels or select necessary channels while confirming the contents thereof.

The television described in the aforementioned Japanese Patent Laying-Open No. 2001-168684 automatically deletes the channels transmitting the television signals having the receiving levels lower than the reference signal level, and hence the user cannot delete unnecessary channels or select necessary channels while confirming the contents thereof.

The television receiver described in the aforementioned Japanese Patent Laying-Open No. 2006-270411 automatically deletes the channels transmitting the television signals having low signal levels, and hence the user cannot delete unnecessary channels or select necessary channels while confirming the contents thereof.

The aforementioned Japanese Patent Laying-Open No. 2001-16524 discloses no operation of deleting a channel on the basis of receiving sensitivity, and hence the user conceivably starts deleting channels transmitting television signals having inferior receiving sensitivity levels by a prescribed operation, in order to delete the channels on the basis of the receiving sensitivity levels. In the display according to the aforementioned Japanese Patent Laying-Open No. 2001-16524, therefore, the user must perform the prescribed operation in order to delete the channels on the basis of the receiving sensitivity levels, and hence this display is time-consuming for the user, and the unnecessary channels cannot be easily deleted.

### SUMMARY OF THE INVENTION

The present invention has been proposed in order to solve the aforementioned problems, and an object of the present invention is to provide a display enabling the user to easily select whether or not to set a display portion not to display an image received from a channel while confirming the contents of the channel on the basis of receiving sensitivity.

A display according to an aspect of the present invention comprises a display portion displaying an image based on a television signal, a receiving sensitivity detection portion detecting receiving sensitivity of the television signal, and a control portion so formed as to control the display portion to display an image received from a channel and displayable on the display portion while displaying a set screen enabling the user to select whether or not to display the image received from the channel and currently displayed on the display portion.

As hereinabove described, the display according to this aspect is provided with the control portion so formed as to control the display portion to display the set screen enabling the user to select whether or not to set the display portion not to display the image received from the channel and currently displayed on the display portion so that the display portion displays the set screen along with the image currently displayed on the display portion, whereby the user can select whether or not to set the display portion not to display the currently displayed image while confirming the contents of the corresponding channel. Further, the display portion displays the set screen on the basis of the receiving sensitivity thereby automatically displaying the set screen on the basis of the receiving sensitivity and prompting the user to set the display portion without starting an operation for deleting the channel, whereby the user can easily select whether or not to set the display portion not to display the image received from the channel.

In the display according to the aforementioned aspect, the control portion is preferably so formed as to control the display portion to display the set screen enabling the user to select whether or not to display the image received from the channel and currently displayed on the display portion on the basis of the receiving sensitivity when first displaying the image received from the channel and displayable on the display portion. According to this structure, the user can set the display portion when first selecting any channel and displaying the image received therefrom on the display portion, thereby setting the display portion to display or not to display the image received therefrom when selecting the channel again.

The display according to the aforementioned aspect preferably further comprises a receiving portion receiving a television signal from a channel having receiving sensitivity higher than first receiving sensitivity, and the control portion is preferably so formed as to control the display portion to display the set screen enabling the user to select whether or not to display the image received from the channel and currently displayed on the display portion when displaying an image received from a channel having receiving sensitivity lower than second receiving sensitivity set higher than the first receiving sensitivity among channels whose television signals are received by the receiving portion. According to this structure, the display portion displays the set screen only when displaying the image received from the channel having the receiving sensitivity lower than prescribed receiving sensitivity among the channels whose television signals are received, whereby the user may not set the display portion as to a channel having excellent receiving sensitivity. Thus, a burden on the user can be reduced.

In this case, the first receiving sensitivity is preferably receiving sensitivity corresponding to a prescribed ratio with respect to the maximum receiving sensitivity in the receiving portion, and the second receiving sensitivity is preferably receiving sensitivity corresponding to a ratio larger than the prescribed ratio with respect to the maximum receiving sensitivity in the receiving portion. According to this structure, the first receiving sensitivity and the second receiving sensitivity are decided by the ratios with respect to the maximum receiving sensitivity, whereby the levels of the first receiving sensitivity and the second receiving sensitivity can be varied with fluctuation of the maximum receiving sensitivity.

In the aforementioned structure comprising the receiving portion, the control portion is preferably so formed as to control the receiving portion to receive only a television signal from a channel having receiving sensitivity higher than the first receiving sensitivity when performing auto presetting. According to this structure, the receiving portion does not receive a television signal from a channel having low receiving sensitivity not displayed on the display portion, whereby the time for the auto presetting can be reduced.

In this case, the control portion is preferably so formed as to initialize the display portion to display images received from all auto-preset channels after the auto presetting. According to this structure, the display portion can display the images received from all auto-preset channels and displayable on the display portion without requiring the user to set the display portion to display the images received from the auto-preset channels and displayable on the display portion.

In the display according to the aforementioned aspect, the control portion is preferably enabled to change setting of the display portion to redisplay an image received from a channel so set that the image is not displayed on the display portion on the basis of an instruction of the user. According to this structure, the user can change the setting of the display portion when erroneously setting the display portion or reviewing the set contents.

In the display according to the aforementioned aspect, the control portion is preferably enabled to change setting of the display portion not to display an image received from a channel so set that the image is displayed on the display portion on the basis of an instruction of the user. According to this structure, the user can change the setting of the display screen when erroneously setting the display portion or reviewing the set contents.

In the aforementioned structure provided with the control portion enabled to change setting of the display portion, the control portion is preferably so formed as to control the display portion to display a set change screen enabling the user to issue an instruction for directing the control portion to change setting of the display portion to redisplay the image received from the channel so set that the image is not displayed on the display portion. According to this structure, the user can easily change the setting of the display portion through the set change screen displayed on the display portion.

In the display according to the aforementioned aspect, the control portion is preferably so formed as to control the display portion to display an image received from a displayable channel on the basis of list data of channels displayable on the display portion, and the list data preferably includes first data for confirming whether or not the corresponding channel is a channel so set that the image is displayed on the display portion. According to this structure, the control portion can control the display portion to display the image received from the channel so set that the image is displayed on the display portion and not to display the image received from the channel so set that the image is not displayed on the display portion on the basis of the first data included in the list data.

In this case, the list data preferably includes second data for confirming that the display portion displays the set screen enabling the user to select whether or not to set the display portion not to display the image received from the channel and currently displayed on the display portion and the user performs the selection. According to this structure, the control portion can control the display portion not to display the set screen when displaying the image again on the basis of the second data included in the list data, whereby the user may not frequently set the display portion.

The display according to the aforementioned aspect preferably further comprises a character information output portion enabled to display character information over the image displayed on the display portion, and the control portion is preferably so formed as to control the display portion to display the set screen with the character information output portion. According to this structure, the display portion displays the set screen over the image displayed thereon, whereby the user can decide whether or not to continuously display the image displayed on the display portion while confirming the image.

The display according to the aforementioned aspect preferably further comprises a receiving portion receiving the television signal, and the control portion is preferably so formed as to control the receiving portion not to receive a television signal from a prescribed channel when the display portion is so set as not to display an image received from the prescribed channel. According to this structure, the time for receiving processing can be reduced as compared with a case where the receiving portion receives the television signal from the prescribed channel to be not displayed on the display portion, whereby the burden on the user can be reduced.

In the display according to the aforementioned aspect, the display is preferably a digital television set capable of receiving a digital television broadcast. According to this structure, a digital television set enabling the user to easily select whether or not to set the display portion not to display an image received from a prescribed channel can be provided.

In the display according to the aforementioned aspect, the display is preferably a television set capable of receiving both of an analog television broadcast and a digital television broadcast. According to this structure, a television set, corresponding to both of the analog television broadcast and the digital television broadcast, enabling the user to easily select whether or not to set the display portion not to display an image received from a prescribed channel can be provided.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram for illustrating the structure of a television set according to an embodiment of the present invention;

FIG. 2 illustrates exemplary channel information array data of the television set according to the embodiment of the present invention shown in FIG. 1;

FIG. 3 illustrates a set screen of the television set according to the embodiment of the present invention shown in FIG. 1;

FIG. 4 illustrates another set screen of the television set according to the embodiment of the present invention shown in FIG. 1;

FIG. 5 illustrates a channel list screen of the television set according to the embodiment of the present invention shown in FIG. 1;

FIG. 6 illustrates a screen for notifying the user that a television signal includes no signal necessary for displaying a television program on the television set according to the embodiment of the present invention shown in FIG. 1; and

FIG. 7 is a flow chart for illustrating a channel switching operation in the television set according to the embodiment of the present invention shown in FIG. 1.

### DESCRIPTION OF THE PREFERRED EMBODIMENTS

An embodiment of the present invention is now described with reference to the accompanying drawings.

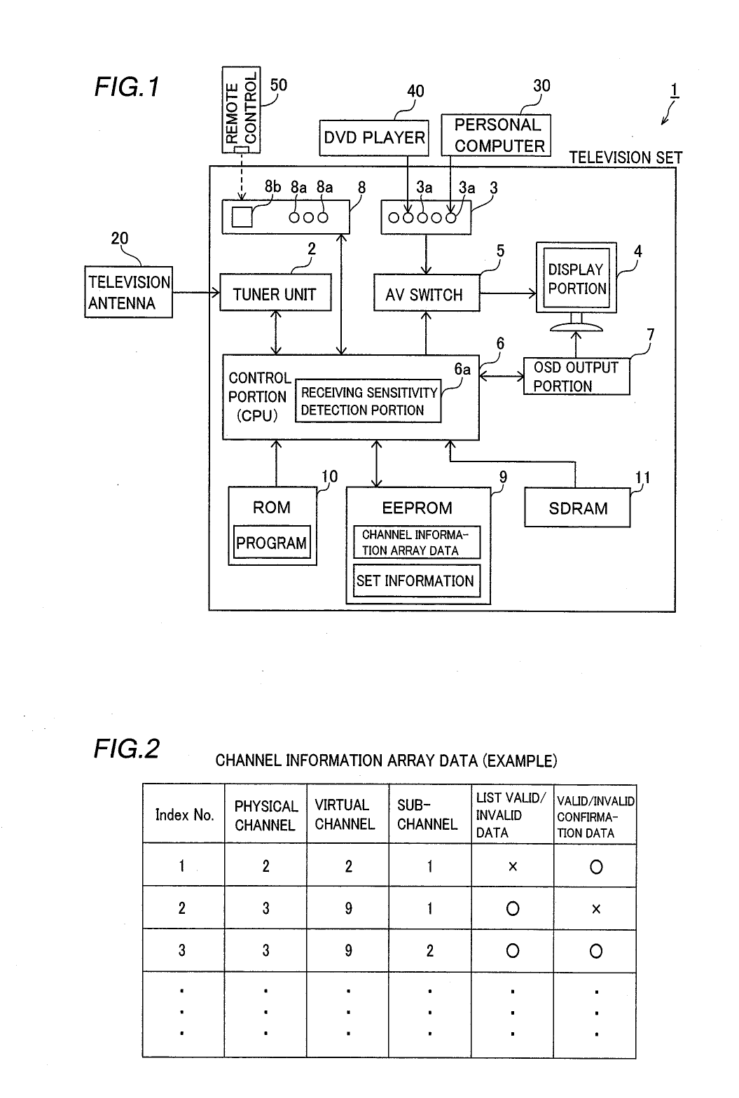

First, the structure of a television set 1 according to the embodiment of the present invention is described with reference to FIG. 1. This embodiment of the present invention is applied to the television set 1 employed as an exemplary display.

As shown in FIG. 1, the television set 1 comprises a tuner unit 2 receiving television signals corresponding to digital broadcasts through a television antenna 20, an external input substrate 3 including a plurality of terminals 3a connected with external apparatuses such as a personal computer 30 and a DVD player 40, a display portion 4 formed by an LCD (liquid crystal display), an AV switch 5 selecting a specific signal from among a plurality of signals received through the tuner unit 2 and the external input substrate 3 and outputting the same to the display portion 4, and a control portion (CPU) 6 controlling the respective portions of the television unit 1. The tuner unit 2 is an example of the “receiving portion” in the present invention.

The television set 1 further comprises an OSD output portion 7 having an OSD (on-screen display) function capable of displaying character information over images displayed on the display portion 4 and an input portion 8 having a plurality of buttons 8a for changing the volume of the television set 1, a channel etc. and changing setting etc. The OSD output portion 7 is an example of the “character information output portion” in the present invention. The input portion 8 includes a receiving portion 8b receiving signals from a remote control 50. The aforementioned volume, the channel etc. can be changed also through the remote control 50. The signals received through the input portion 8 or from the remote control 50 are input in the control portion 6, which in turn controls the respective portions of the television set 1 to perform prescribed processing on the basis of the signals.

The tuner unit 2 is so formed as to detect television signals of channels watchable in a prescribed district and acquire information through an auto-preset function of the television set 1. The control portion 6 controls an EEPROM 9 to store the acquired information on the channels. More specifically, the control portion 6 controls the EEPROM 9 to store information on channels, included in those whose television signals are detected by the tuner unit 2, having receiving sensitivity levels, detected by a receiving sensitivity detection portion 6a included in the control portion 6, higher than 80% with respect to the maximum receiving sensitivity as channel information array data (see FIGS. 1 and 2). Thus, channels having receiving sensitivity levels lower than an ordinary level are also auto-preset. The auto-preset function is a function of automatically setting watchable channels to a state where television signals thereof are receivable when the user simply selects the district where the television set 1 is set. The tuner unit 2 is further so formed as to receive a corresponding television signal and output the obtained signal to the AV switch 5 through the control portion 6 on the basis of an instruction from the control portion 6 when the user specifies a channel.

The display portion 4 is so formed as to display images based on the television signal received from the AV switch 5 and signals received from the external apparatuses and to display the character information received from the OSD output portion 7 over the images.

The control portion 6 so controls the AV switch 5 as to select a specific signal from among a plurality of signals received through the tuner unit 2 and the external input substrate 3.

The control portion 6 is so formed as to control the television set 1 according to set information stored in the EEPROM 9 along with the channel information array data and programs stored in a ROM 10. The set information includes information on setting related to display on the display portion 4, for example. More specifically, the set information includes information on setting related to parental control, information on setting related to captions (subtitles), information on setting related to language etc. This set information is set in a state (initial state) corresponding to a standard mode of the television set 1 when the television set 1 is shipped from a factory. Data can be written in and erased from the EEPROM 9, and changed set information is written in the EEPROM 9 every time the user changes the set information through the input portion 8 or the like.

According to this embodiment, the control portion 6 is so formed as to control the display portion 4 to display images received from a prescribed channel through the AV switch 5 on the basis of the channel information array data. The channel information array data includes the information on the channels having the receiving sensitivity levels higher than 80%, as described above. More specifically, the channel information array data includes information on physical channels corresponding to prescribed frequencies of television signals, virtual channels corresponding to the physical channels respectively and subchannels included in the virtual channels, as shown in FIG. 2. The control portion 6 is so formed as to control the tuner unit 2 to receive a television signal of a prescribed frequency on the basis of the information on a physical channel corresponding to a prescribed channel selected by the user. Therefore, the tuner unit 2 can receive television signals from the channels included in the channel information array data, and hence the channels included in the channel information array data are those displayable on the display portion 4. The channel information array data further includes list valid/invalid data for determining whether or not any channel included in the channels displayable on the display portion 4 is a channel so set that images thereof are not displayed on the display portion 4. The list valid/invalid data is an example of the “first data” in the present invention. The channel information array data further includes valid/invalid confirmation data for confirming that the display portion 4 displays a set screen 4a described later and list valid/invalid setting is performed. The valid/invalid confirmation data is an example of the “second data” in the present invention. Immediately after the auto presetting, the list valid/invalid data is set valid on all channels, while the valid/invalid confirmation data is set unconfirmed on all channels. In the exemplary channel information array data shown in FIG. 2, the list valid/invalid data of an index number 1 is set invalid, and the valid/invalid confirmation data thereof is set confirmed.

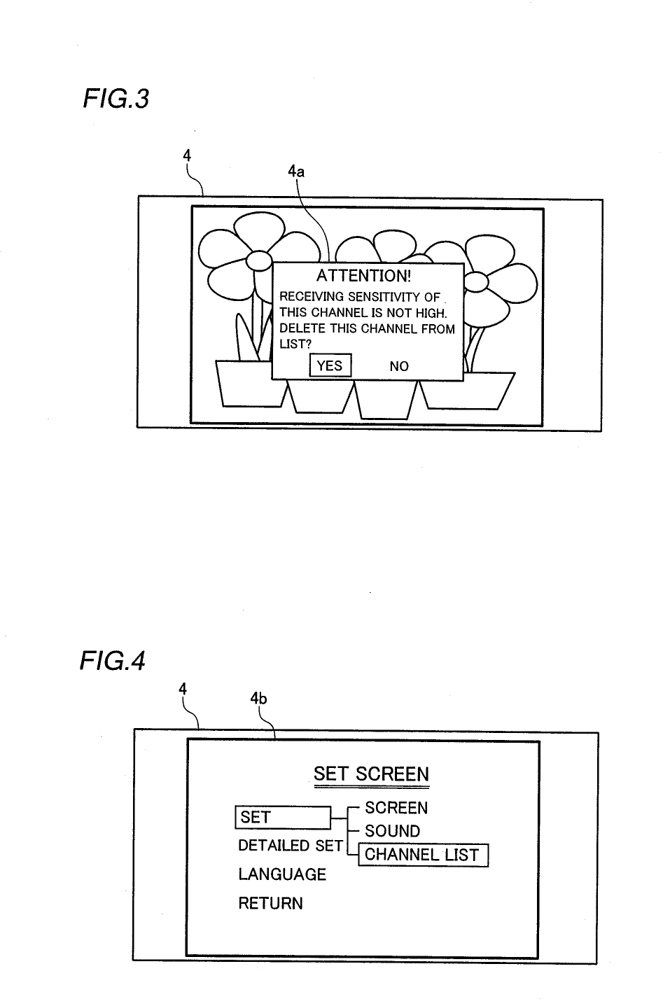

As shown in FIG. 3, the control portion 6 is so formed as to control the OSD output portion 7 so that the display portion 4 displays the set screen 4a enabling the user to select whether or not to set the display portion 4 not to display images received from a channel and currently displayed on the display portion 4 over the images received from the channel and currently displayed on the display portion 4. Thus, the user can determine whether or not to set the display portion 4 not to display the currently displayed images while confirming the contents of the corresponding channel. Further, the control portion 6 is so formed as to rewrite the channel information array data to change the list valid/invalid data from valid to invalid when the user selects “yes” on the set screen 4a and to maintain the list valid/invalid data valid when the user selects “no”. The control portion 6 is further so formed as to rewrite the channel information array data to change the valid/invalid confirmation data from unconfirmed to confirmed when the display portion 4 displays the set screen 4a and the user selects “yes” or “no”.

According to this embodiment, the control portion 6 is so formed as to control the display portion 4 to display channels having valid list valid/invalid data among the channels included in the channel information array data while not displaying channels having invalid list valid/invalid data. In other words, the display portion 4 displays only the channels having valid list valid/invalid data when the user performs a channel switching operation through the remote control 50.

The control portion 6 is so formed as to control the display portion 4 to display the set screen 4a on the basis of receiving sensitivity. More specifically, the control portion 6 is so formed as to control the display portion 4 to display the set screen 4a when displaying a channel, included in the channel information array data, having unconfirmed valid/invalid confirmation data and receiving sensitivity lower than 90%. In other words, the control portion 6 controls the display portion 4 to display the set screen 4a when displaying the images received from the channel, included in the channels whose television signals are received by the tuner unit 2, having unconfirmed valid/invalid confirmation data and receiving sensitivity lower than 90% set higher than 80%. Thus, the control portion 6 is so formed as to control the display portion 4 to display the set screen 4a when the valid/invalid confirmation data is unconfirmed, whereby the display portion 4 displays the set screen 4a when first displaying the images received from the channel selected by the user.

As shown in FIG. 4, the control portion 6 is so formed as to control the display portion 4 to display another set screen 4b allowing the user to confirm and change set information of the television set 1 by performing a prescribed operation. The user can change the setting by operating the input portion 8 or the remote control 50 with reference to this set screen 4b. When the user selects the item of a channel list on the set screen 4b, the display portion 4 displays a channel list screen 4c, as shown in FIG. 5. The channel list screen 4c is an example of the “set change screen” in the present invention. The control portion 6 is so formed as to rewrite the list valid/invalid data included in the channel information array data on the basis of an operation performed by the user for switching valid/invalid of each channel on the channel list screen 4c. Thus, the user can set the display portion 4 to redisplay images received from a specific channel so set that the images are not displayed on the display portion 4, and to set the display portion 4 not to display images received from another specific channel so set that the images are displayed on the display portion 4.

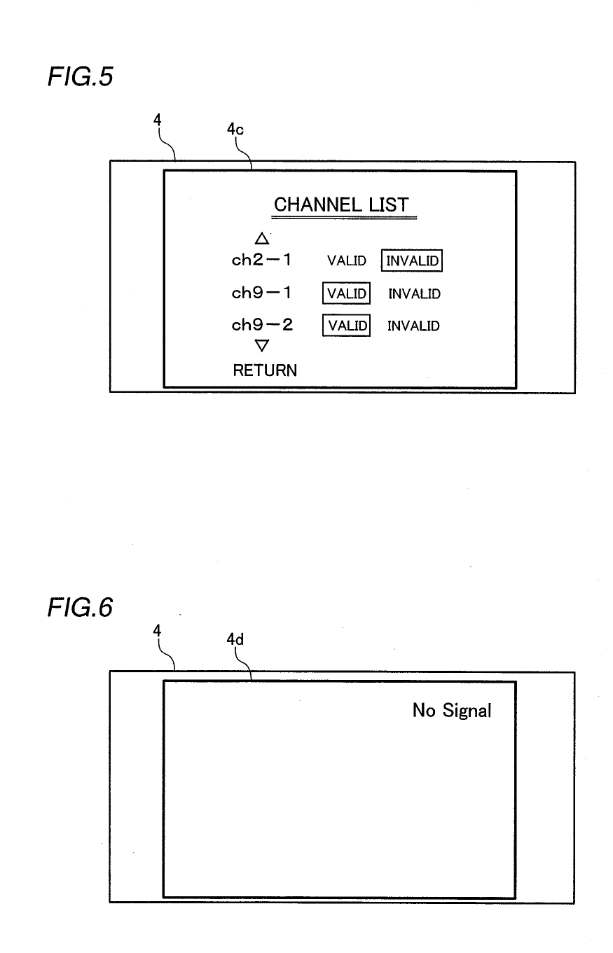

The control portion 6 determines whether or not each television signal received by the tuner unit 2 includes a signal of images or sound necessary for displaying the corresponding television program, and controls the tuner unit 2 to output this signal to the display portion 4 through the AV switch 5 if the television signal includes this signal. If the television signal includes no signal of images or sound necessary for displaying the television program, on the other hand, the control portion 6 controls the OSD output portion 7 to display a screen 4d for notifying the user that the television signal includes no signal necessary for displaying the television program on the display portion 4, as shown in FIG. 6.

An SDRAM 11 is a memory temporarily storing data when the control portion 6 performs an operation.

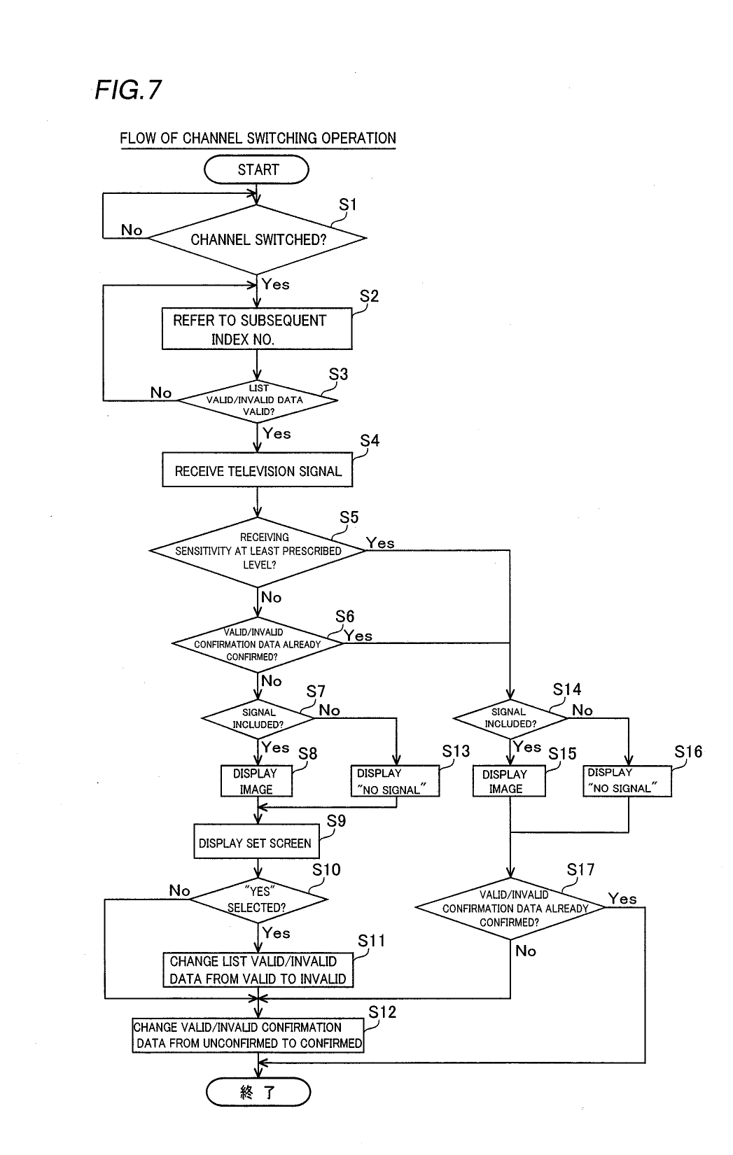

A channel switching operation in the television set 1 according to the embodiment of the present invention is now described with reference to FIG. 7. While the television set 1 enables the user to switch the channel either by direct selection for directly inputting a channel number and switching the channel through any button 8a of the input portion 8 or the remote control 50 or by up-down selection for sequentially switching channels along channel numbers, the case of switching the channel by up-down selection is described in this embodiment.

At a step S1, the control portion 6 determines whether or not the user switches the channel, and repeats this determination when determining that the user does not switch the channel. When determining that the user switches the channel, on the other hand, the control portion 6 refers to data of an index number subsequent to the index number (see FIG. 2) corresponding to the channel whose images are currently displayed on the display portion 4 at a step S2. At a step S3, the control portion 6 determines whether or not the list valid/invalid data of the index number referred to is valid, and returns to the step S2 to refer to data of a further subsequent index number when determining that the list valid/invalid data is not valid. When the control portion 6 determines that the list valid/invalid data is not valid (invalid), therefore, the display portion 4 does not display the images received from the corresponding channel. When determining that the list valid/invalid data is valid, on the other hand, the control portion 6 the tuner unit 2 to receive the television signal from the corresponding channel at a step S4.

Then, the control portion 6 determines whether or not the receiving sensitivity of the signal received from the channel is at least 90% at a step S5, and determines whether or not the valid/invalid confirmation data of the corresponding channel is already confirmed at a step S6 when determining that the receiving sensitivity is lower than 90%. When determining that the valid/invalid confirmation data is not yet confirmed (unconfirmed), the control portion 6 determines whether or not the received television signal includes a signal such as a video signal necessary for displaying the corresponding television program on the display portion 4 at a step S7, and controls the display portion 4 to display images on the basis of the video signal included in the television signal at a step S8 when determining that the television signal includes this video signal. When determining that the television signal includes no signal necessary for displaying the television program, on the other hand, the control portion 6 controls the display portion 4 to display the screen 4d (see FIG. 6) notifying the user that the television signal includes no signal necessary for displaying the television program at a step S13. After the steps S8 and S13, the control portion 6 controls the display portion 4 to display the set screen 4a (see FIG. 3) over the currently displayed screen 4d at a step S9. Then, the control portion 6 determines whether or not “YES” is selected on the set screen 4a at a step S10, and changes the list valid/invalid data from valid to invalid at a step S11 when determining that “YES” is selected. When determining that not “YES” but “NO” is selected, on the other hand, the control portion 6 maintains the list valid/invalid data valid. Then, the control portion 6 changes the valid/invalid confirmation data from unconfirmed to confirmed at a step S12, and terminates the operation.

When determining that the receiving sensitivity is at least 90% at the step S5 or determining that the valid/invalid data of the corresponding channel is already confirmed at the step S6, the control portion 6 determines whether or not the received television signal includes the signal such as the video signal necessary for displaying the television program on the display portion 4 at a step S14, and controls the control portion 4 to display the images based on the video signal included in the television signal at a step S15 when determining that the television signal includes this video signal. When determining that the television signal includes no signal necessary for displaying the television program on the display portion 4, on the other hand, the control portion 6 controls the display portion 4 to display the screen 4d (see FIG. 6) notifying the user that the television signal includes no signal necessary for displaying the television program at a step S16. After the steps S15 and S16, the control portion 6 determines whether or not the valid/invalid confirmation data of the corresponding channel is already confirmed at a step S17. When determining that the valid/invalid confirmation data is already confirmed, the control portion 6 terminates the operation. If determining that the valid/invalid confirmation data is not yet confirmed (unconfirmed), on the other hand, the control portion 6 changes the valid/invalid data from unconfirmed to confirmed at the step S12, and terminates the operation.

According to this embodiment, as hereinabove described, the television set 1 is provided with the control portion 6 so formed as to control the display portion 4 to display the set screen 4a enabling the user to select whether or not to set the display portion 4 not to display the images received from the channel and currently displayed on the display portion 4 on the basis of the receiving sensitivity so that the display portion 4 displays the set screen 4a along with the images currently displayed on the display portion 4, whereby the user can select whether or not to set the display portion 4 not to display the currently displayed images while confirming the contents of the corresponding channel. Further, the display portion 4 displays the set screen 4a on the basis of the receiving sensitivity thereby automatically displaying the set screen 4a on the basis of the receiving sensitivity and prompting the user to set the display portion 4 without starting an operation for deleting the channel, whereby the user can easily select whether or not to set the display portion 4 not to display the images received from the channel.

According to this embodiment, the television set 1 is provided with the tuner unit 2 receiving the television signals from the channels having receiving sensitivity levels higher than 80% with respect to the maximum receiving sensitivity and the control portion 6 is so formed as to control the display portion 4 to display the set screen 4a when displaying the images received from the channel having receiving sensitivity lower than 90% set higher than 80% with respect to the maximum receiving sensitivity so that the display portion 4 displays the set screen 4a only when displaying images received from a channel, included in channels whose television signals are received, having receiving sensitivity of not more than 90%, whereby the user may perform no setting with respect to channels having excellent receiving sensitivity levels. Thus, a burden on the user can be reduced.

According to this embodiment, the channel information array data is so formed as to include the valid/invalid confirmation data for confirming that the set screen 4a is displayed and set on the display portion 4 so that the control portion 6 can control the display portion 4 not to display the set screen 4a again on the basis of the valid/invalid confirmation data for confirming that the set screen 4a is displayed and set on the display portion 4, whereby the user may not frequently set the display portion 4.

According to this embodiment, the television set 1 is provided with the OSD output portion 7 capable of displaying the character information over the images displayed on the display portion 4 and the control portion 6 is so formed as to control the display portion 4 to display the set screen 4a with the OSD output portion 7 so that the display portion 4 displays the set screen 4a over the images displayed thereon, whereby the user can decide whether or not to continuously display the currently displayed images on the display portion 4 while confirming the images.

According to this embodiment, the television set 1 is provided with the tuner unit 2 receiving the television signals and the control portion 6 is so formed as to control the tuner unit 2 not to receive a television signal from a prescribed channel when the display portion 4 is so set as not to display images received from the prescribed channel so that the time for receiving processing can be reduced as compared with a case where the tuner unit 2 receives the television signal from the channel so set that the images thereof are not displayed on the display portion 4, whereby the burden on the user can be reduced.

Although the present invention has been described and illustrated in detail, it is clearly understood that the same is by way of illustration and example only and is not to be taken by way of limitation, the spirit and scope of the present invention being limited only by the terms of the appended claims.

For example, while the present invention is applied to the television set 1 employed as the exemplary display in the aforementioned embodiment, the present invention is not restricted to this but is also applicable to a display other than the television set 1, so far as the same can be set not to display images on the basis of receiving sensitivity.

While the tuner unit 2 receives the television signals corresponding to digital broadcasts in the aforementioned embodiment, the present invention is not restricted to this but the tuner unit 2 may alternatively receive television signals of analog broadcasts or both of television signals of digital and analog broadcasts.

While the receiving sensitivity of 80% with respect to the maximum receiving sensitivity is shown as an example of the first receiving sensitivity and the receiving sensitivity of 90% with respect to the maximum receiving sensitivity is shown as an example of the second receiving sensitivity in the aforementioned embodiment, the present invention is not restricted to this but levels other than 80% and 90% with respect to the maximum receiving sensitivity may alternatively be selected, so far as the second receiving sensitivity is set higher than the first receiving sensitivity.

What is claimed is:

1. A display comprising:
a display portion displaying an image based on a television signal;
a receiving sensitivity detection portion detecting receiving sensitivity of said television signal; and
a control portion so formed as to control said display portion to display an image received from a channel and displayable on said display portion while displaying a set screen enabling the user to select whether or not to display said image received from said channel and currently displayed on said display portion.

2. The display according to claim 1, wherein
said control portion is so formed as to control said display portion to display said set screen enabling the user to select whether or not to display said image received from said channel and currently displayed on said display portion on the basis of said receiving sensitivity when first displaying said image received from said channel and displayable on said display portion.

3. The display according to claim 1, further comprising a receiving portion receiving a television signal from a channel having receiving sensitivity higher than first receiving sensitivity, wherein
said control portion is so formed as to control said display portion to display said set screen enabling the user to select whether or not to display said image received from said channel and currently displayed on said display portion when displaying an image received from a channel having receiving sensitivity lower than second receiving sensitivity set higher than said first receiving sensitivity among channels whose television signals are received by said receiving portion.

4. The display according to claim 3, wherein
said first receiving sensitivity is receiving sensitivity corresponding to a prescribed ratio with respect to the maximum receiving sensitivity in said receiving portion, and
said second receiving sensitivity is receiving sensitivity corresponding to a ratio larger than said prescribed ratio with respect to the maximum receiving sensitivity in said receiving portion.

5. The display according to claim 3, wherein
said control portion is so formed as to control said receiving portion to receive only a television signal from a channel having receiving sensitivity higher than said first receiving sensitivity when performing auto presetting.

6. The display according to claim 5, wherein
said control portion is so formed as to initialize said display portion to display images received from all auto-preset channels after said auto presetting.

7. The display according to claim 1, wherein
said control portion is enabled to change setting of said display portion to redisplay an image received from a channel so set that said image is not displayed on said display portion on the basis of an instruction of the user.

8. The display according to claim 1, wherein
said control portion is enabled to change setting of said display portion not to display an image received from a channel so set that said image is displayed on said display portion on the basis of an instruction of the user.

9. The display according to claim 7, wherein
said control portion is so formed as to control said display portion to display a set change screen enabling the user to issue an instruction for directing said control portion to change setting of said display portion to redisplay said image received from said channel so set that said image is not displayed on said display portion.

10. The display according to claim 1, wherein
said control portion is so formed as to control said display portion to display an image received from a displayable channel on the basis of list data of channels displayable on said display portion, and
said list data includes first data for confirming whether or not corresponding said channel is a channel so set that said image is displayed on said display portion.

11. The display according to claim 10, wherein
said list data includes second data for confirming that said display portion displays said set screen enabling the user to select whether or not to set said display portion not to display said image received from said channel and currently displayed on said display portion and the user performs said selection.

12. The display according to claim 1, further comprising a character information output portion enabled to display character information over said image displayed on said display portion, wherein
said control portion is so formed as to control said display portion to display said set screen with said character information output portion.

13. The display according to claim 1, further comprising a receiving portion receiving said television signal, wherein
said control portion is so formed as to control said receiving portion not to receive a television signal from a prescribed channel when said display portion is so set as not to display an image received from said prescribed channel.

14. The display according to claim 1, wherein
said display is a digital television set capable of receiving a digital television broadcast.

15. The display according to claim 1, wherein
said display is a television set capable of receiving both of an analog television broadcast and a digital television broadcast.
